(19) United States
(12) Patent Application Publication
(10) Pub. No.: US 2014/0027556 A1
(43) Pub. Date: Jan. 30, 2014

(54) RETRACTABLE VEHICLE CORD

(71) Applicant: Kevin Christensen, Williston, ND (US)

(72) Inventor: Kevin Christensen, Williston, ND (US)

(21) Appl. No.: 13/561,045

(22) Filed: Jul. 29, 2012

(51) Int. Cl. H02G 3/00

(52) U.S. Cl. 242/378

(57) ABSTRACT

The present invention is a retractable vehicle cord that includes a vehicle grill disposed on a front of a vehicle and a horizontal slot disposed underneath the vehicle grill, a retractable extension cord that extends through the horizontal slot that includes a male electrical plug that is utilized to provide electrical power as desired by a user and a connector bulb disposed before the second end of the retractable extension cord, the connector bulb protects the retracting spool and serves as a barrier when the retractable extension cord is retracted back into the retracting spool. The retractable vehicle cord also includes a retracting spool that retracts the retractable extension cord; and a second cord that is attached to the retracting spool.

### TECHNICAL FIELD & BACKGROUND

Currently there are limited options for an electrical extending cord that effectively transfers electrical power to a resting vehicle. Motorists familiar with cold climate understand the necessity of electrical support on all vehicles, especially semi-trucks and diesel pick-up trucks to ensure continued engine functionality. However, this practice often results in lost cords and/or delayed mobility.

The present invention generally relates to a retractable cord. More specifically, the invention is a retractable vehicle cord.

It is an object of the invention to provide a retractable vehicle cord that is connected to a cord from a vehicle block heater that extends from a vehicle engine to a vehicle exterior.

It is an object of the invention to provide a retractable vehicle cord that no longer requires a user to carry an electrical extension cord in their vehicle for emergency electrical use.

It is an object of the invention to provide a retractable vehicle cord that can be used by a relatively small passenger vehicle or a relatively larger commercial vehicle such as a commercial truck.

What is really needed is a retractable vehicle cord that is connected to a cord from a vehicle block heater that extends from a vehicle engine to a vehicle exterior that no longer requires a user to carry an electrical extension cord in their vehicle for emergency electrical use that can be used by a relatively small passenger vehicle or a relatively larger commercial vehicle such as a commercial truck.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front environmental view of a retractable vehicle cord, according to an embodiment of the present invention.

FIG. 1B illustrates a front view of a retractable vehicle cord, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

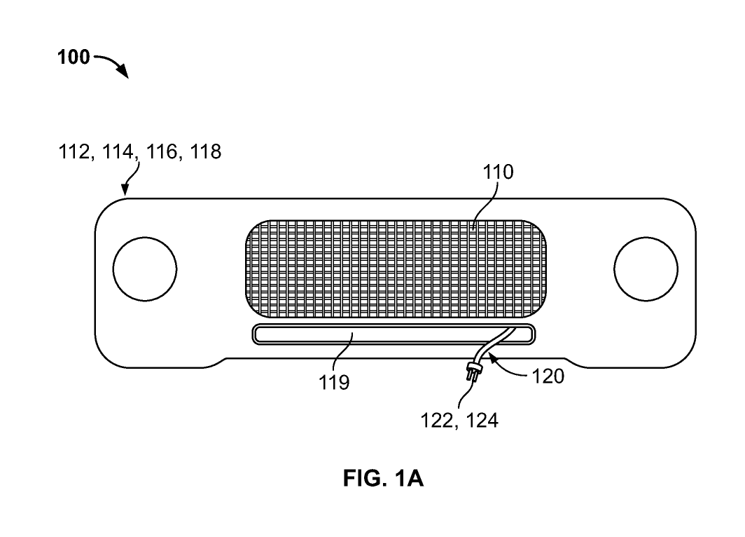

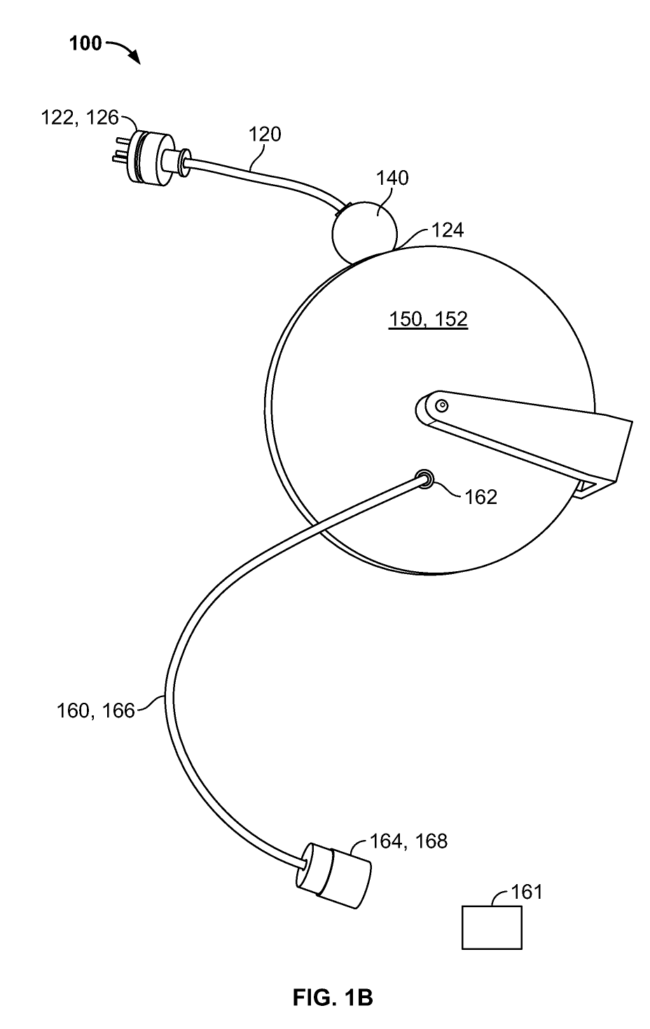

FIG. 1A illustrates a front environmental view of a retractable vehicle cord 100, according to an embodiment of the present invention.

The retractable vehicle cord 100 includes a vehicle grill 110 and a retractable extension cord 120. The vehicle grill 110 can be disposed on a front of a vehicle 112 such as a passenger vehicle 114, a pick-up truck 116, a commercial truck 118 or any other suitable vehicle. The vehicle grill 110 also includes a horizontal slot 119 that is disposed underneath the vehicle grill 110, although the horizontal slot 119 can be disposed above the vehicle grill 110 (not shown) as well or on any suitable location on the vehicle grill 110 or be a suitable vertical slot (not shown) disposed on any suitable location such as on the sides of the vehicle grill 110 as well. The retractable extension cord 120 has a first end 122 that extends through the horizontal slot 119. The first end 122 of the retractable extension cord 120 includes a male electrical plug 124 that can be utilized to provide electrical power as desired by a user. The retractable extension cord 120 has reversed cord ends in contrast to a traditional typical extension cord. Additional details regarding the retractable extension cord 120 are provided in subsequent FIG. 1B and its description.

FIG. 1B illustrates a front view of a retractable vehicle cord 100, according to an embodiment of the present invention.

The retractable vehicle cord 100 illustrated and described in FIG. 1B includes similar elements that are illustrated and described in FIG. 1A and its description and include a similar retractable extension cord 120 with a similar first end 122, a similar second end 124 and a similar male electrical plug 126.

The retractable vehicle cord 100 additionally includes a connector bulb 140, a retracting spool 150 and a second cord 160. The connector bulb 140 is disposed before the second end 124 of the retractable extension cord 120 and assists retracting the retractable extension cord 120. The retracting spool 150 receives the second end 124 of the retractable extension cord 120 and retracts the retractable extension cord 120 when not in use. The connector bulb 140 also protects the retracting spool 150 and serves as a barrier when the retractable extension cord 120 is retracted back into the retracting spool 150. The connector bulb 140 is made of hard rubber, hard plastic or other suitable material to protect the retracting spool 150. The retracting spool 150 is typically spring-loaded and has a generally circular shape 152 but can be any suitable type of retracting spool 150. The second cord 160 includes a first end 162 and a second end 164. The first end 162 of the second cord 160 is attached to the retracting spool 150 and is typically a block heater cord 166 of a vehicle engine of the vehicle 112. The second end 164 of the second cord 160 has a female electrical plug 168 that is disposed on the second end 164 of the second cord 160. The female electrical plug 168 can be plugged into a block heater 161 of the vehicle 112.

The retractable vehicle cord is an extension cord with an exterior male electrical plug that introduces an approach to accessing electrical power. Mounted in the engine compartment of a vehicle, the retractable vehicle cord is a connection unit from the block heater of a vehicle to an external voltage source, where the end male plug is exposed from the front of the vehicle. When in use, the operator simply pulls the cord from the engine and plugs it in for power, in the event the driver forgets to unplug the cord thereafter, it will retract via the embedded spiraling mechanism, returning the cord to the vehicle engine. The retractable vehicle cord eliminates the need for carrying surplus extension cords in an effort to sustain an engine during relatively harsh weather conditions. The feature of a retractable electrical power cord provides drivers with a method for maximizing automotive operation.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A retractable vehicle cord, comprises:
a vehicle grill disposed on a front of a vehicle, said vehicle grill includes a horizontal slot, said horizontal slot disposed underneath said vehicle grill;
a retractable extension cord with a first end and a second end, said retractable extension cord and said first end extend through said horizontal slot, said first end of said retractable extension cord includes a male electrical plug that is utilized to provide electrical power as desired by a user;
a connector bulb disposed before said second end of said retractable extension cord, said connector bulb protects said retracting spool and serves as a barrier when said retractable extension cord is retracted back into said retracting spool;
a retracting spool that receives said second end of said retractable extension cord and retracts said retractable extension cord; and
a second cord with a first end and a second end, said first end of said second cord is attached to said retracting spool.

2. The retractable vehicle cord according to claim 1, wherein said vehicle is a pick-up truck.

3. The retractable vehicle cord according to claim 1, wherein said vehicle is a passenger vehicle.

4. The retractable vehicle cord according to claim 1, wherein said vehicle is a commercial truck.

5. The retractable vehicle cord according to claim 1, wherein said retracting spool is spring-loaded.

6. The retractable vehicle cord according to claim 1, wherein said connector bulb is made of a selected one of a hard rubber connector bulb and a hard plastic connector bulb.

7. The retractable vehicle cord according to claim 1, wherein said second cord is a block heater cord of a vehicle engine of said vehicle.

8. The retractable vehicle cord according to claim 1, wherein said second end of said second cord has a female electrical plug, said female electric plug is disposed on said second end of said second cord.

9. A retractable vehicle cord, comprises:
a vehicle grill disposed on a front of a vehicle, said vehicle grill includes a horizontal slot, said horizontal slot disposed underneath said vehicle grill;
a retractable extension cord with a first end and a second end, said retractable extension cord and said first end extend through said horizontal slot, said first end of said retractable extension cord includes a male electrical plug that is utilized to provide electrical power as desired by a user;
a connector bulb disposed before said second end of said retractable extension cord, said connector bulb protects said retracting spool and serves as a barrier when said retractable extension cord is retracted back into said retracting spool;
a generally circular shape spring-loaded retracting spool that receives said second end of said retractable extension cord and retracts said retractable extension cord; and
a second cord with a first end and a second end, said first end of said second cord is attached to said retracting spool.

10. The retractable vehicle cord according to claim 9, wherein said vehicle is a pick-up truck.

11. The retractable vehicle cord according to claim 9, wherein said vehicle is a passenger vehicle.

12. The retractable vehicle cord according to claim 9, wherein said vehicle is a commercial truck.

13. The retractable vehicle cord according to claim 9, wherein said connector bulb is made of a selected one of a hard rubber connector bulb and a hard plastic connector bulb.

14. The retractable vehicle cord according to claim 9, wherein said second cord is a block heater cord of a vehicle engine of said vehicle.

15. The retractable vehicle cord according to claim 9, wherein said second end of said second cord has a female electrical plug, said female electric plug is disposed on said second end of said second cord.

16. The retractable vehicle cord according to claim 9, wherein said female electrical plug is plugged into said block heater of said vehicle.

17. A retractable vehicle cord, comprises:
a vehicle grill disposed on a front of a vehicle, said vehicle grill includes a horizontal slot, said horizontal slot disposed underneath said vehicle grill;
a retractable extension cord with a first end and a second end, said retractable extension cord and said first end extend through said horizontal slot, said first end of said retractable extension cord includes a male electrical plug that is utilized to provide electrical power as desired by a user;
a connector bulb disposed before said second end of said retractable extension cord, said connector bulb protects said retracting spool and serves as a barrier when said retractable extension cord is retracted back into said retracting spool, said connector bulb is a selected one of a hard rubber connector bulb and a hard plastic connector bulb;
a generally circular shape spring-loaded retracting spool that receives said second end of said retractable extension cord and retracts said retractable extension cord; and
a second cord with a first end and a second end, said first end of said second cord is attached to said retracting spool, said second cord is a block heater cord of a vehicle engine of said vehicle, said second end of said second cord has a female electrical plug, said female electric plug is disposed on said second end of said second cord, said female electrical plug is plugged into said block heater of said vehicle.

18. The retractable vehicle cord according to claim 17, wherein said vehicle is a pick-up truck.

19. The retractable vehicle cord according to claim 17, wherein said vehicle is a passenger vehicle.

20. The retractable vehicle cord according to claim 17, wherein said vehicle is a commercial truck.
